(19) United States
(12) Patent Application Publication
(10) Pub. No.: US 2024/0420423 A1
(43) Pub. Date: Dec. 19, 2024

(54) DISTRIBUTED, SCALABLE, TRACE-BASED IMAGING EARTH MODEL REPRESENTATION

(71) Applicant: Schlumberger Technology Corporation, Sugar Land, TX (US)

(72) Inventors: Nicolas Euler, Houston, TX (US); Dragos V. Baciu, Houston, TX (US); Charles Mood, Houston, TX (US)

(21) Appl. No.: 18/715,951

(22) PCT Filed: May 4, 2023
(86) PCT No.: PCT/US2023/020998

§ 371 Date: Jun. 3, 2024

Related U.S. Application Data
(60) Provisional application No. 63/364,209, filed on May 5, 2022.

(51) Int. Cl. G06T 17/20; E21B 44/00; E21B 49/00; G06T 15/06; G06T 15/08; G06T 19/20

(52) U.S. Cl. CPC G06T 17/20; E21B 44/00; E21B 49/00; G06T 15/06; G06T 15/08; G06T 19/20; E21B 2200/20; G06T 2219/2016

(57) ABSTRACT

A method includes assembling a model including a plurality of independent objects. The independent objects include surfaces, properties, and zones. The method also includes decomposing the model into vertical columns, tiles, or both. The method also includes discretizing an incoming request into the vertical columns, the tiles, or both. In response to the discretized request, the method also includes performing a vertical pin analysis on the model to retrieve a portion of the surfaces, a portion of the properties, or both that are geo-located in the vertical columns, the tiles, or both. The method also includes modelling the retrieved portions to generate an output. The method also includes comparing the output with subsurface data. The method also includes modifying the model based at least partially upon the comparison.

### CROSS-REFERENCE TO RELATED APPLICATIONS

This application claims priority to U.S. Provisional Patent Application having Ser. No. 63/364,209, which was filed on May 5, 2022 and is incorporated herein by reference in its entirety.

### BACKGROUND

A large earth model may be used for imaging and inversion disciplines such as initial model building, Kirchhoff depth migration, and tomography. This is particularly helpful as structures become more complex (e.g., more and more thin singularities such as salt overhang, thin lithology beds are being added) and more property details are added (e.g., finer property resolution). The approach may include partitioning the space into volumes using various surfaces (e.g., horizons, faults, geobody), and then filling those volumes with various properties (e.g., velocities, structure tensors). In the computer aided design (CAD) domain, this approach is known as volume or solid modeling and can be achieved by different technologies such as constructive solid geometry, boundary representation, and/or cellular partitioning. In recent years, due to the increasing demand in the size of the model and the corresponding amount of surface and property data to process, a model can no longer fit on a single work machine.

### SUMMARY

A method is disclosed herein. The method includes assembling a model including a plurality of independent objects. The independent objects include surfaces, properties, and zones. The method also includes decomposing the model into vertical columns, tiles, or both. The method also includes discretizing an incoming request into the vertical columns, the tiles, or both. In response to the discretized request, the method also includes performing a vertical pin analysis on the model to retrieve a portion of the surfaces, a portion of the properties, or both that are geo-located in the vertical columns, the tiles, or both. The method also includes modelling the retrieved portions to produce an output. The method also includes comparing the output with subsurface data. The method also includes modifying the model based at least partially upon the comparison.

A computing system is also disclosed. The computing system includes one or more processors and a memory system. The memory system includes one or more non-transitory computer-readable media storing instructions that, when executed by at least one of the one or more processors, cause the computing system to perform operations. The operations include assembling a model having a plurality of independent objects that participate in the model based at least partially upon a set of instructions governing assembly of the model. The independent objects include surfaces, properties, and zones. The operations also include decomposing the model into vertical columns, tiles, or both. A smallest unit of the vertical columns is a vertical stack of single 3D grid cells. Each tile includes a 3D volume. The operations also include discretizing an incoming request into the vertical columns, the tiles, or both that cover a zone of interest of the request to drive assembly of a portion of the model. The operations also include formulating the request by assembling the model using the set of instructions and performing a vertical pin analysis on the model to retrieve a portion of the surfaces and a portion of the properties that are geo-located in the vertical columns, the tiles, or both. The operations also include processing the request by localizing the 3D volume and applying an operator to model data that is geo-located in the vertical columns, the tiles, or both to produce an output. The operations also include comparing the output with subsurface data measured at a wellsite. The operations also include modifying the model based at least partially upon the comparison.

A non-transitory computer-readable medium is also disclosed. The medium stores instructions that, when executed by at least one processor of a computing system, cause the computing system to perform operations. The operations include assembling a model having a plurality of independent objects that participate in the model based at least partially upon a set of instructions governing assembly of the model. The independent objects include surfaces, properties, and zones. The surfaces include 2D grid surfaces, mesh surfaces, or both. The properties include a 3D grid of values, a 1D property value profile, a constant value, or a combination thereof. The zones are each bounded by a portion of the surfaces and have a portion of the properties therein. The operations also include decomposing the model into vertical columns, tiles, or both. A smallest unit of the vertical columns is a vertical stack of single 3D grid cells. Each tile includes a 3D volume. Each tile is interpreted with the set of instructions as a self-contained model. The decomposition of the model allows the model to have any size and to switch between the vertical columns and the 3D volume, thereby providing scalability. The operations also include discretizing an incoming request into the vertical columns, the tiles, or both that cover a zone of interest of the request to drive assembly of a portion of the model. The operations also include formulating the request by assembling the model on-the-fly using the set of instructions and performing a vertical pin analysis on the model to retrieve a portion of the surfaces and a portion of the properties that are geo-located in the vertical columns, the tiles, or both. The operations also include processing the request by localizing the 3D volume and applying an operator to model data that is geo-located in the vertical columns, the tiles, or both to produce an output. Localizing the 3D volume includes identifying relationships between the request and the vertical columns, the tiles, or both. The operator includes a mathematical function. The operations also include comparing the output with subsurface data measured at a wellsite. The operations also include modifying the model based at least partially upon the comparison. The operations also include transmitting a signal to cause a wellsite action to be performed based at least partially upon the modified model.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIGS. 1A, 1B, 1C, 1D, 2, 3A, and 3B illustrate simplified, schematic views of an oilfield and its operation, according to an embodiment.

FIG. 4 illustrates a disassembled structure of a model (e.g., in storage), according to an embodiment.

FIG. 5 illustrates an assembled view of the model, according to an embodiment.

FIG. 6A illustrates a perspective view of the model split into a plurality of vertical columns, according to an embodiment.

FIG. 6B illustrates a perspective view of one of the vertical columns split into a plurality of tiles, according to an embodiment.

FIG. 6C illustrates a perspective view of a combination of a vertical column and a plurality of tiles, according to an embodiment.

FIG. 7 illustrates a schematic view of distributed model data access, according to an embodiment.

FIG. 8 illustrates a schematic view of a decomposition of distributed data access for surface and properties, according to an embodiment.

FIG. 9 illustrates a schematic view of a conceptual model meta-information view, according to an embodiment.

FIG. 10A illustrates a synthetic land model, and FIG. 10B illustrates a synthetic marine model, according to an embodiment.

FIG. 11 illustrates a cross-section of the model, according to an embodiment.

FIG. 12 illustrates a vertical pin passing through point Pt1, according to an embodiment.

FIG. 13 illustrates a 3D view and a top-down view of a query on the model, according to an embodiment.

FIG. 14 illustrates a decomposed query geometry with 8 tiles (T1-T8), according to an embodiment.

FIG. 15 illustrates a single tile (T9) spanning the query geometry, according to an embodiment.

FIG. 16 illustrates a flowchart of a method for assembling a distributed, scalable, trace-based imaging earth model representation (e.g., on-the-fly), according to an embodiment.

FIG. 17 illustrates a computing system for performing at least a portion of the method(s) disclosed herein, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of embodiments of the invention. However, it will be apparent to one of ordinary skill in the art that embodiments of the invention may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object could be termed a second object, and, similarly, a second object could be termed a first object, without departing from the scope of the embodiments of the invention. The first object and the second object are both objects, respectively, but they are not to be considered the same object.

The terminology used in the description of the invention herein is for the purpose of describing particular embodiments only and is not intended to be limiting of embodiments of the invention. As used in the description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques and workflows that are in accordance with some embodiments. Some operations in the processing procedures, methods, techniques and workflows disclosed herein may be combined and/or the order of some operations may be changed.

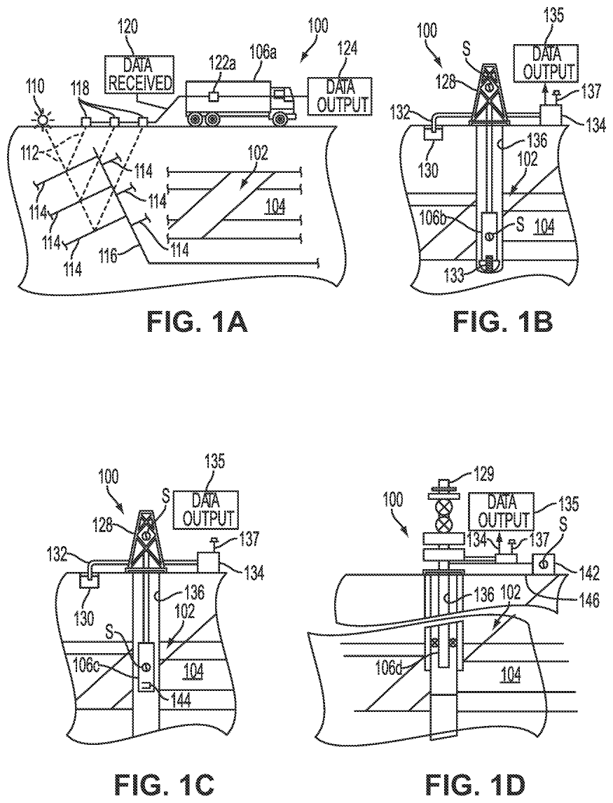

FIGS. 1A-1D illustrate simplified, schematic views of oilfield 100 having subterranean formation 102 containing reservoir 104 therein in accordance with implementations of various technologies and techniques described herein. Although embodiments of the present method are at least partially described herein with reference to an oilfield, it will be appreciated that this is merely an illustrative example. Embodiments of the present method may be employed in any application in which visualizing, modeling, or otherwise identifying subsurface features (e.g., geological features) may be useful. Examples outside of the oilfield context include subsurface mapping for wind arrays and/or solar arrays, geothermal energy production, mining operations, offshore/deep ocean applications, etc.

FIG. 1A illustrates a survey operation being performed by a survey tool, such as seismic truck 106.1, to measure properties of the subterranean formation. The survey operation is a seismic survey operation for producing sound vibrations. In FIG. 1A, one such sound vibration, e.g., sound vibration 112 generated by source 110, reflects off horizons 114 in earth formation 116. A set of sound vibrations is received by sensors, such as geophone-receivers 118, situated on the earth's surface. The data received 120 is provided as input data to a computer 122.1 of a seismic truck 106.1, and responsive to the input data, computer 122.1 generates seismic data output 124. This seismic data output may be stored, transmitted or further processed as desired, for example, by data reduction.

FIG. 1B illustrates a drilling operation being performed by drilling tools 106.2 suspended by rig 128 and advanced into subterranean formations 102 to form wellbore 136. Mud pit 130 is used to draw drilling mud into the drilling tools via flow line 132 for circulating drilling mud down through the drilling tools, then up wellbore 136 and back to the surface. The drilling mud is typically filtered and returned to the mud pit. A circulating system may be used for storing, controlling, or filtering the flowing drilling mud. The drilling tools are advanced into subterranean formations 102 to reach reservoir 104. Each well may target one or more reservoirs. The drilling tools are adapted for measuring downhole properties using logging while drilling tools. The logging while drilling tools may also be adapted for taking core sample 133 as shown.

Computer facilities may be positioned at various locations about the oilfield 100 (e.g., the surface unit 134) and/or at remote locations. Surface unit 134 may be used to communicate with the drilling tools and/or offsite operations, as well as with other surface or downhole sensors. Surface unit 134 is capable of communicating with the drilling tools to send commands to the drilling tools, and to receive data therefrom. Surface unit 134 may also collect data generated during the drilling operation and produce data output 135, which may then be stored or transmitted.

Sensors (S), such as gauges, may be positioned about oilfield 100 to collect data relating to various oilfield operations as described previously. As shown, sensor (S) is positioned in one or more locations in the drilling tools and/or at rig 128 to measure drilling parameters, such as weight on bit, torque on bit, pressures, temperatures, flow rates, compositions, rotary speed, and/or other parameters of the field operation. Sensors (S) may also be positioned in one or more locations in the circulating system.

Drilling tools 106.2 may include a bottom hole assembly (BHA) (not shown), generally referenced, near the drill bit (e.g., within several drill collar lengths from the drill bit). The bottom hole assembly includes capabilities for measuring, processing, and storing information, as well as communicating with surface unit 134. The bottom hole assembly further includes drill collars for performing various other measurement functions.

The bottom hole assembly may include a communication subassembly that communicates with surface unit 134. The communication subassembly is adapted to send signals to and receive signals from the surface using a communications channel such as mud pulse telemetry, electro-magnetic telemetry, or wired drill pipe communications. The communication subassembly may include, for example, a transmitter that generates a signal, such as an acoustic or electromagnetic signal, which is representative of the measured drilling parameters. It will be appreciated by one of skill in the art that a variety of telemetry systems may be employed, such as wired drill pipe, electromagnetic or other known telemetry systems.

Typically, the wellbore is drilled according to a drilling plan that is established prior to drilling. The drilling plan typically sets forth equipment, pressures, trajectories and/or other parameters that define the drilling process for the wellsite. The drilling operation may then be performed according to the drilling plan. However, as information is gathered, the drilling operation may need to deviate from the drilling plan. Additionally, as drilling or other operations are performed, the subsurface conditions may change. The earth model may also need adjustment as new information is collected

The data gathered by sensors (S) may be collected by surface unit 134 and/or other data collection sources for analysis or other processing. The data collected by sensors (S) may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis. The data may be stored in separate databases, or combined into a single database.

Surface unit 134 may include transceiver 137 to allow communications between surface unit 134 and various portions of the oilfield 100 or other locations. Surface unit 134 may also be provided with or functionally connected to one or more controllers (not shown) for actuating mechanisms at oilfield 100. Surface unit 134 may then send command signals to oilfield 100 in response to data received. Surface unit 134 may receive commands via transceiver 137 or may itself execute commands to the controller. A processor may be provided to analyze the data (locally or remotely), make the decisions and/or actuate the controller. In this manner, oilfield 100 may be selectively adjusted based on the data collected. This technique may be used to optimize (or improve) portions of the field operation, such as controlling drilling, weight on bit, pump rates, or other parameters. These adjustments may be made automatically based on computer protocol, and/or manually by an operator. In some cases, well plans may be adjusted to select optimum (or improved) operating conditions, or to avoid problems.

FIG. 1C illustrates a wireline operation being performed by wireline tool 106.3 suspended by rig 128 and into wellbore 136 of FIG. 1B. Wireline tool 106.3 is adapted for deployment into wellbore 136 for generating well logs, performing downhole tests and/or collecting samples. Wireline tool 106.3 may be used to provide another method and apparatus for performing a seismic survey operation. Wireline tool 106.3 may, for example, have an explosive, radioactive, electrical, or acoustic energy source 144 that sends and/or receives electrical signals to surrounding subterranean formations 102 and fluids therein.

Wireline tool 106.3 may be operatively connected to, for example, geophones 118 and a computer 122.1 of a seismic truck 106.1 of FIG. 1A. Wireline tool 106.3 may also provide data to surface unit 134. Surface unit 134 may collect data generated during the wireline operation and may produce data output 135 that may be stored or transmitted. Wireline tool 106.3 may be positioned at various depths in the wellbore 136 to provide a survey or other information relating to the subterranean formation 102.

Sensors (S), such as gauges, may be positioned about oilfield 100 to collect data relating to various field operations as described previously. As shown, sensor S is positioned in wireline tool 106.3 to measure downhole parameters which relate to, for example porosity, permeability, fluid composition and/or other parameters of the field operation.

FIG. 1D illustrates a production operation being performed by production tool 106.4 deployed from a production unit or Christmas tree 129 and into completed wellbore 136 for drawing fluid from the downhole reservoirs into surface facilities 142. The fluid flows from reservoir 104 through perforations in the casing (not shown) and into production tool 106.4 in wellbore 136 and to surface facilities 142 via gathering network 146.

Sensors (S), such as gauges, may be positioned about oilfield 100 to collect data relating to various field operations as described previously. As shown, the sensor (S) may be positioned in production tool 106.4 or associated equipment, such as Christmas tree 129, gathering network 146, surface facility 142, and/or the production facility, to measure fluid parameters, such as fluid composition, flow rates, pressures, temperatures, and/or other parameters of the production operation.

Production may also include injection wells for added recovery. One or more gathering facilities may be operatively connected to one or more of the wellsites for selectively collecting downhole fluids from the wellsite(s).

While FIGS. 1B-1D illustrate tools used to measure properties of an oilfield, it will be appreciated that the tools may be used in connection with non-oilfield operations, such as gas fields, mines, aquifers, storage or other subterranean facilities. Also, while certain data acquisition tools are depicted, it will be appreciated that various measurement tools capable of sensing parameters, such as seismic two-way travel time, density, resistivity, production rate, etc., of the subterranean formation and/or its geological formations may be used. Various sensors (S) may be located at various positions along the wellbore and/or the monitoring tools to collect and/or monitor the desired data. Other sources of data may also be provided from offsite locations.

The field configurations of FIGS. 1A-ID are intended to provide a brief description of an example of a field usable with oilfield application frameworks. Part of, or the entirety, of oilfield 100 may be on land, water and/or sea. Also, while a single field measured at a single location is depicted, oilfield applications may be utilized with any combination of one or more oilfields, one or more processing facilities and one or more wellsites.

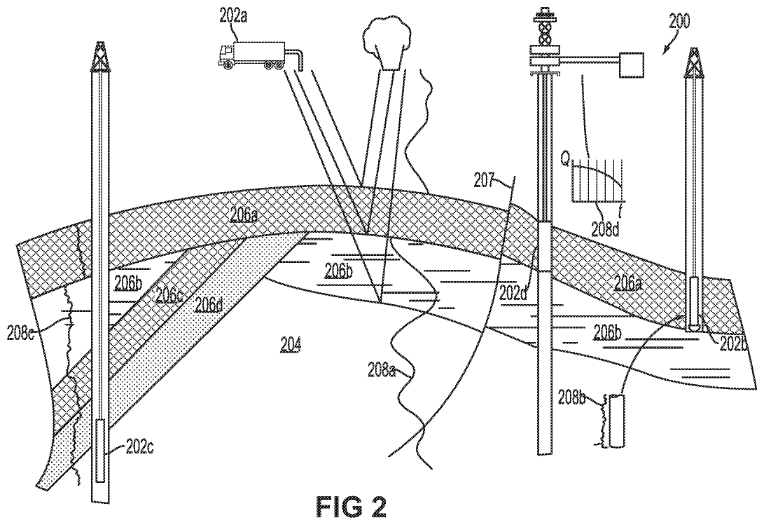

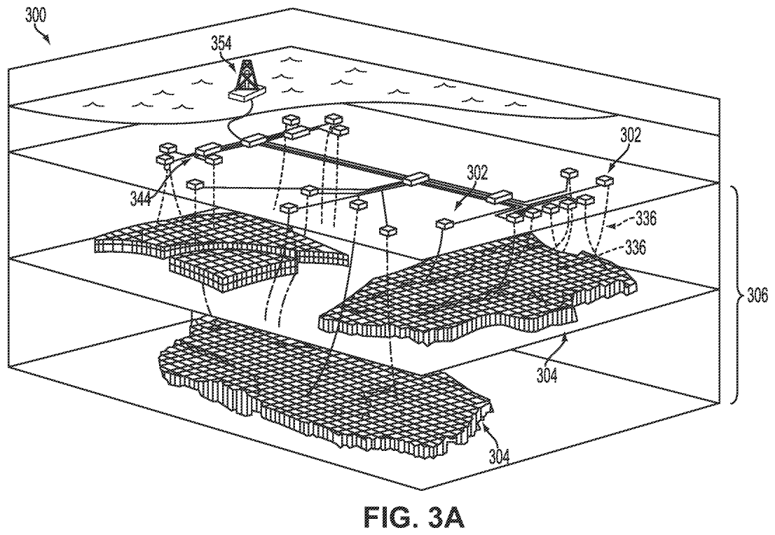

FIG. 2 illustrates a schematic view, partially in cross section of oilfield 200 having data acquisition tools 202.1, 202.2, 202.3 and 202.4 positioned at various locations along oilfield 200 for collecting data of subterranean formation 204 in accordance with implementations of various technologies and techniques described herein. Data acquisition tools 202.1-202.4 may be the same as data acquisition tools 106.1-106.4 of FIGS. 1A-1D, respectively, or others not depicted. As shown, data acquisition tools 202.1-202.4 generate data plots or measurements 208.1-208.4, respectively. These data plots are depicted along oilfield 200 to demonstrate the data generated by the various operations.

Data plots 208.1-208.3 are examples of static data plots that may be generated by data acquisition tools 202.1-202.3, respectively; however, it should be understood that data plots 208.1-208.3 may also be data plots that are updated in real time. These measurements may be analyzed to better define the properties of the formation(s) and/or determine the accuracy of the measurements and/or for checking for errors. The plots of each of the respective measurements may be aligned and scaled for comparison and verification of the properties.

Static data plot 208.1 is a seismic two-way response over a period of time. Static plot 208.2 is core sample data measured from a core sample of the formation 204. The core sample may be used to provide data, such as a graph of the density, porosity, permeability, or some other physical property of the core sample over the length of the core. Tests for density and viscosity may be performed on the fluids in the core at varying pressures and temperatures. Static data plot 208.3 is a logging trace that typically provides a resistivity or other measurement of the formation at various depths.

A production decline curve or graph 208.4 is a dynamic data plot of the fluid flow rate over time. The production decline curve typically provides the production rate as a function of time. As the fluid flows through the wellbore, measurements are taken of fluid properties, such as flow rates, pressures, composition, etc.

Other data may also be collected, such as historical data, user inputs, economic information, and/or other measurement data and other parameters of interest. As described below, the static and dynamic measurements may be analyzed and used to generate models of the subterranean formation to determine characteristics thereof. Similar measurements may also be used to measure changes in formation aspects over time.

The subterranean structure 204 has a plurality of geological formations 206.1-206.4. As shown, this structure has several formations or layers, including a shale layer 206.1, a carbonate layer 206.2, a shale layer 206.3 and a sand layer 206.4. A fault 207 extends through the shale layer 206.1 and the carbonate layer 206.2. The static data acquisition tools are adapted to take measurements and detect characteristics of the formations.

While a specific subterranean formation with specific geological structures is depicted, it will be appreciated that oilfield 200 may contain a variety of geological structures and/or formations, sometimes having extreme complexity. In some locations, typically below the water line, fluid may occupy pore spaces of the formations. Each of the measurement devices may be used to measure properties of the formations and/or its geological features. While each acquisition tool is shown as being in specific locations in oilfield 200, it will be appreciated that one or more types of measurement may be taken at one or more locations across one or more fields or other locations for comparison and/or analysis.

The data collected from various sources, such as the data acquisition tools of FIG. 2, may then be processed and/or evaluated. Typically, seismic data displayed in static data plot 208.1 from data acquisition tool 202.1 is used by a geophysicist to determine characteristics of the subterranean formations and features. The core data shown in static plot 208.2 and/or log data from well log 208.3 are typically used by a geologist to determine various characteristics of the subterranean formation. The production data from graph 208.4 is typically used by the reservoir engineer to determine fluid flow reservoir characteristics. The data analyzed by the geologist, geophysicist and the reservoir engineer may be analyzed using modeling techniques.

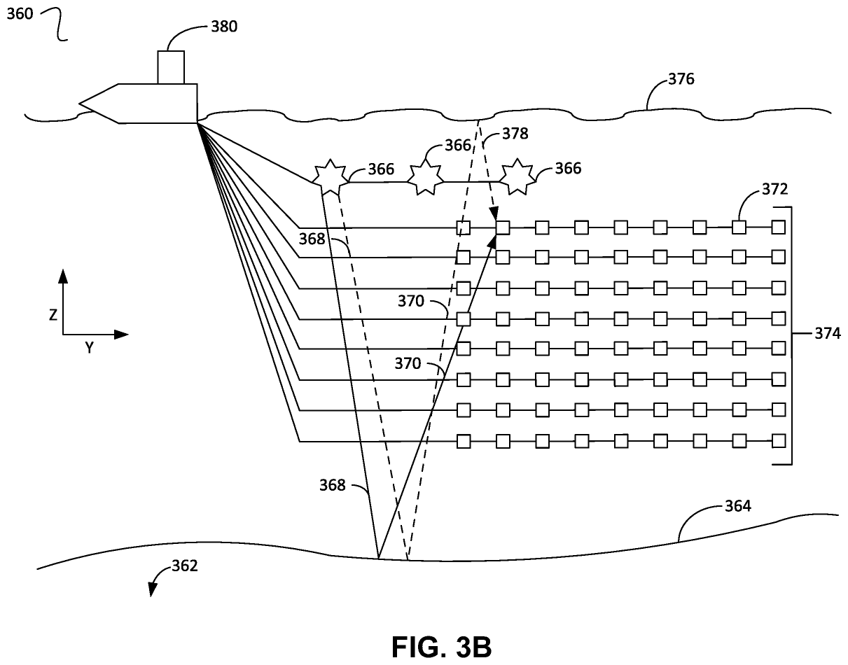

FIG. 3A illustrates an oilfield 300 for performing production operations in accordance with implementations of various technologies and techniques described herein. As shown, the oilfield has a plurality of wellsites 302 operatively connected to central processing facility 354. The oilfield configuration of FIG. 3A is not intended to limit the scope of the oilfield application system. Part, or all, of the oilfield may be on land and/or sea. Also, while a single oilfield with a single processing facility and a plurality of wellsites is depicted, any combination of one or more oilfields, one or more processing facilities and one or more wellsites may be present.

Each wellsite 302 has equipment that forms wellbore 336 into the earth. The wellbores extend through subterranean formations 306 including reservoirs 304. These reservoirs 304 contain fluids, such as hydrocarbons. The wellsites draw fluid from the reservoirs and pass them to the processing facilities via surface networks 344. The surface networks 344 have tubing and control mechanisms for controlling the flow of fluids from the wellsite to processing facility 354.

Attention is now directed to FIG. 3B, which illustrates a side view of a marine-based survey 360 of a subterranean subsurface 362 in accordance with one or more implementations of various techniques described herein. Subsurface 362 includes seafloor surface 364. Seismic sources 366 may include marine sources such as vibroseis or airguns, which may propagate seismic waves 368 (e.g., energy signals) into the Earth over an extended period of time or at a nearly instantaneous energy provided by impulsive sources. The seismic waves may be propagated by marine sources as a frequency sweep signal. For example, marine sources of the vibroseis type may initially emit a seismic wave at a low frequency (e.g., 5 Hz) and increase the seismic wave to a high frequency (e.g., 80-90 Hz) over time.

The component(s) of the seismic waves 368 may be reflected and converted by seafloor surface 364 (i.e., reflector), and seismic wave reflections 370 may be received by a plurality of seismic receivers 372. Seismic receivers 372 may be disposed on a plurality of streamers (i.e., streamer array 374). The seismic receivers 372 may generate electrical signals representative of the received seismic wave reflections 370. The electrical signals may be embedded with information regarding the subsurface 362 and captured as a record of seismic data.

In one implementation, each streamer may include streamer steering devices such as a bird, a deflector, a tail buoy and the like, which are not illustrated in this application. The streamer steering devices may be used to control the position of the streamers in accordance with the techniques described herein.

In one implementation, seismic wave reflections 370 may travel upward and reach the water/air interface at the water surface 376, a portion of reflections 370 may then reflect downward again (i.e., sea-surface ghost waves 378) and be received by the plurality of seismic receivers 372. The sea-surface ghost waves 378 may be referred to as surface multiples. The point on the water surface 376 at which the wave is reflected downward is generally referred to as the downward reflection point.

The electrical signals may be transmitted to a vessel 380 via transmission cables, wireless communication or the like. The vessel 380 may then transmit the electrical signals to a data processing center. Alternatively, the vessel 380 may include an onboard computer capable of processing the electrical signals (i.e., seismic data). Those skilled in the art having the benefit of this disclosure will appreciate that this illustration is highly idealized. For instance, surveys may be of formations deep beneath the surface. The formations may typically include multiple reflectors, some of which may include dipping events, and may generate multiple reflections (including wave conversion) for receipt by the seismic receivers 372. In one implementation, the seismic data may be processed to generate a seismic image of the subsurface 362.

Marine seismic acquisition systems tow each streamer in streamer array 374 at the same depth (e.g., 5-10 m). However, marine based survey 360 may tow each streamer in streamer array 374 at different depths such that seismic data may be acquired and processed in a manner that avoids the effects of destructive interference due to sea-surface ghost waves. For instance, marine-based survey 360 of FIG. 3B illustrates eight streamers towed by vessel 380 at eight different depths. The depth of each streamer may be controlled and maintained using the birds disposed on each streamer.

### Distributed Scalable Trace-Based Imaging Earth Model Representation Assembled On-the-Fly

The system and method described herein can include a hybrid approach that is based on a boundary representation technique and a meshless model construction technique. The system and method can include solving construction queries (e.g., localization) on-demand by combining the usage of vertical pins and geological meta-information and/or instructions. As a result, the system and method can provide a distributed, scalable, geophysical ray-traceable earth model that can be constructed on-the-fly. As used herein, distributed refers to the capacity of parallelizing operations and/or data to multiple computer nodes. As used herein, scalable refers to the capacity to treat and/or process a model of any size and to treat and/or process any number of (e.g., simultaneous) requests. As used herein, trace-based and/or ray-traceable refer to suited to the application of geophysical techniques to simulate the propagation of a seismic wave in the earth medium (e.g., using ray approximation). As used herein, on-the-fly refers to preparing the assembled model on-demand and/or in real-time at the geo-locality of the requests with no prior notice.

The assembly of the distributed scalable trace-based imaging earth model representation on-the-fly can include defining a data model where multiple independent objects are participating in the model based on a set of instructions governing its assembly. As used herein, participate refers to defining the model structure, the model boundaries, the model change of medium, the model rock-physics behavior, or a combination thereof. The objects can include surfaces (e.g., 2D grid surface, mesh surface), properties (e.g., regular 3D grid, 1D property profile, constant), zones, or a combination thereof. The model can be decomposed into smaller vertical columns or tiles, where each tile is itself considered to be a self-contained model. As used herein, a self-contained model refers to each representative unit being self-sufficient such that it is able to be used (e.g., run) on its own. The smallest possible representative unit for a column can be a vertical stack of single 3D grid cells. Queries can be constructed (e.g., localization) on-the-fly by combining the usage of vertical pins and a set of geological meta-information instructions. The data queries can drive of the model assembly. The query can be viewed as the decision maker for the determination of how much data to make available and/or as a definer of the model aperture to be readily available.

### Data Model—Object Independence and Participation

Each contributing object to the model (e.g., surface, property) can be independent but can participate in one or multiple models. The earth model can be defined as a collection of surfaces, properties, and/or zones. The surfaces and properties can be represented and stored as independent, self-contained objects. Each composing object can be one or more distinct dataset(s) in storage that can be accessed independently of any other objects. The objects can be self-contained in the sense that the corresponding datasets fully describe the object by providing both the meta-data and bulk data for the object.

Properties and surfaces can be represented by values fields and a geo-localization lattice. Those representations can include, for example, surface grid/high field, triangular mesh, and for property regular 3D grid, irregular 3D. Each object can have its own grid definition and orientation. Different objects can have a different grid definition and/or value resolution and yet be part of the same model. The data model can allow and promote sharing objects between different models. For example, a given surface in storage can belong to any number of different models. The model representation in storage can contain a set of instructions that specify which objects (e.g., surfaces, properties) contribute to this model and how (e.g., zone classification).

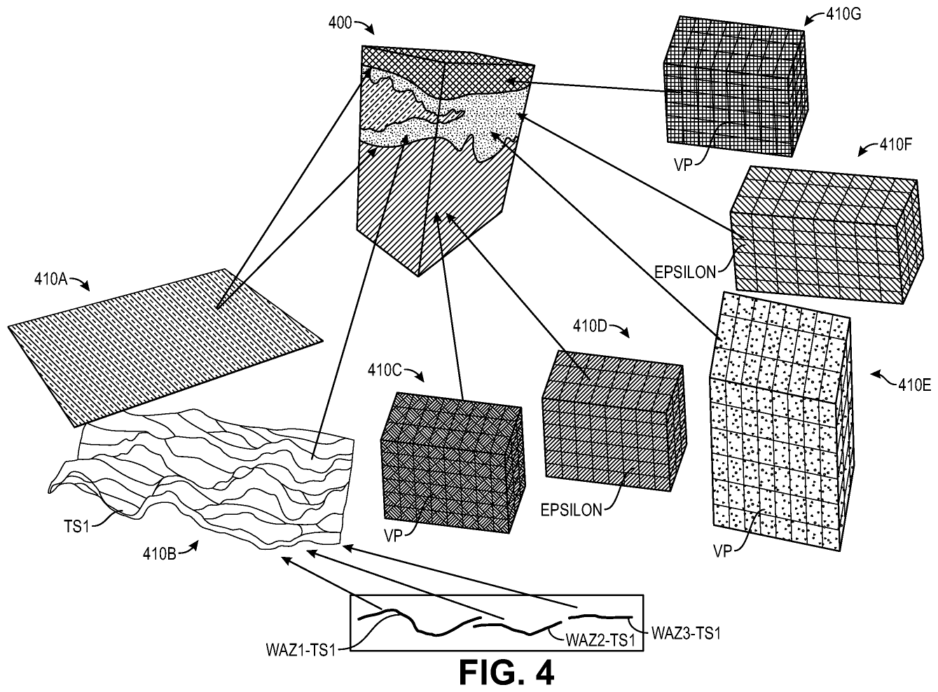

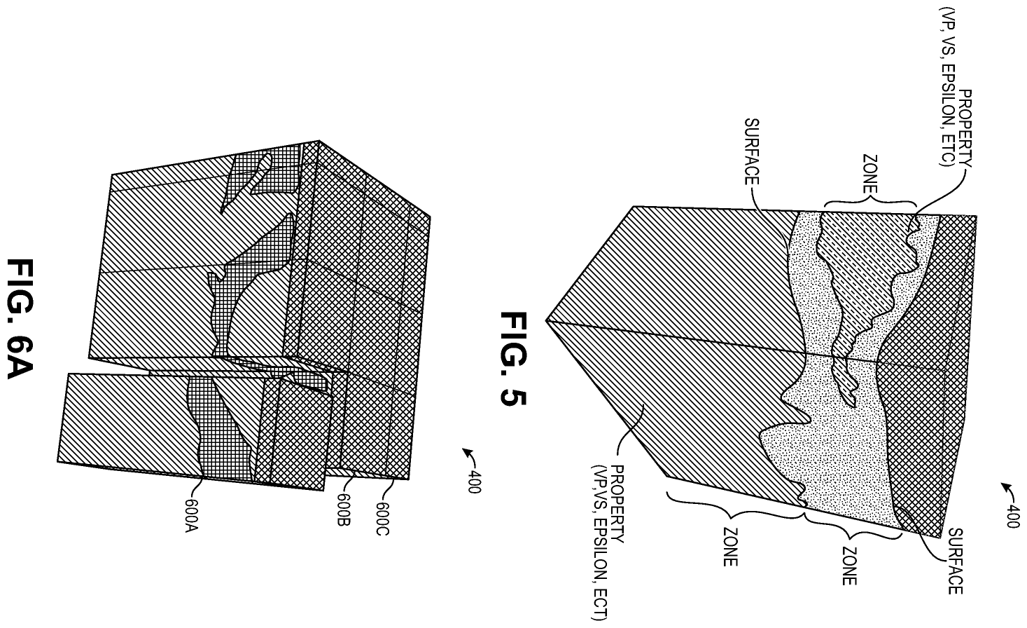

FIG. 4 illustrates a disassembled structure of a model 400 (e.g., in storage), according to an embodiment. Software components can access contributing objects 410A-410G in storage and assemble the model 400 in memory (e.g., RAM).

FIG. 5 illustrates an assembled view of the model 400, according to an embodiment. The memory/logic view of the model 400 can be accessed and/or interpolated at any point in the model space. Zone classification can be imposed. Ray tracing can be performed. This is the concept of the live model where the individual components can be put together in a single model view in memory. Multi-user access can be possible. The access is fast because data is accessed from memory. The data model 400 is open and can be extended to accommodate multiple representations of surfaces or properties, for example, surfaces represented as triangle mesh.

Traditionally, model building can be error prone and time-consuming. For example, when a model 400 is represented as a single monolithic object, the entire model may be re-created with every error. The distributed object representation makes the model building process faster because model creation is merely setting meta data (e.g., instructions on how to assemble the model). In addition, the model 400 can be composed from objects of different resolutions. This also provides economical use of storage. More particularly, objects can be shared between models, so they don't have to be duplicated with every model.

### Horizontal Scalability—Models can be Broken Down in Tiles and Each Tile is Model.

Large models may not fit into a single computer's RAM. To enable the representation of such large models, the data model can allow splitting the model into tiles. A tile is a square cuboid with the same depth (e.g., height) as the model. The data model for one tile is the same as for a model. In other words, the same software components can operate on either a tile, or on a model, which is a collection of tiles. The tiles can be distributed over multiple computers, for example, in a cloud compute engine. This enables unbound horizontal scalability.

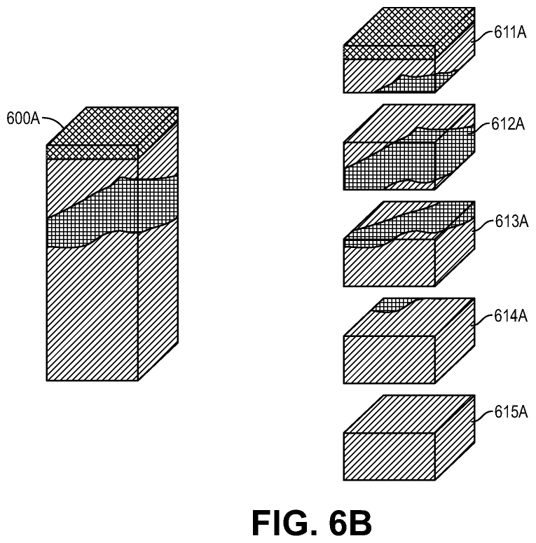

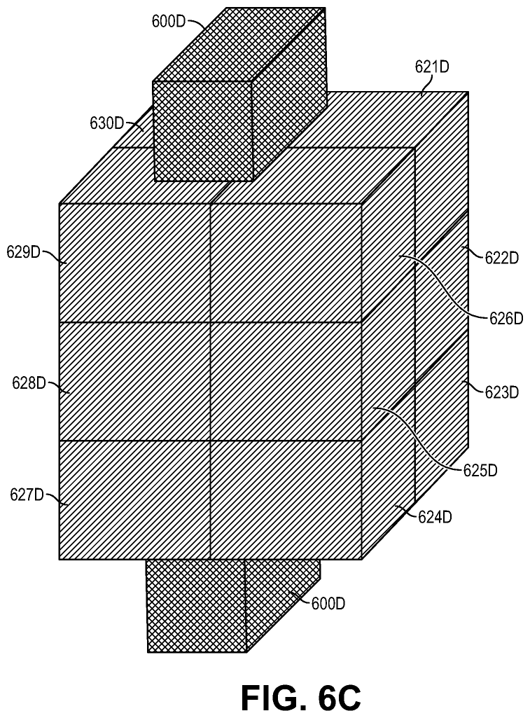

FIG. 6A illustrates a perspective view of the model 400 split into a plurality of vertical columns 600A-600C, according to an embodiment. In other words, FIG. 6A shows a discretization of the model 400 into the vertical columns 600A-600C. The vertical columns 600A-600C may have the same depth as the model 400.

FIG. 6B illustrates a perspective view of the vertical column 600A split into a plurality of tiles 611A-615A, according to an embodiment. The tiles 611A-615A may have any depth up to and including the depth of a vertical column 600A. Conventional systems have a 1:1 correspondence between the size of the vertical columns and the size of the tiles. In contrast, the model 400 described herein can be discretized vertically as well as horizontally. This may be an advantage for models that are very deep. In this case, a vertical column of single grid cells may not fit in the memory of a computer node, but a set of vertically stacked tiles can be used to distribute the column 600A among many computer nodes.

FIG. 6C illustrates a perspective view of a combination of a vertical column 600D and a plurality of tiles 621D-630D, according to an embodiment. FIG. 6C illustrates the flexibility of the model discretization where no assumptions have been made on the alignment of the tiles 621D-630D to the vertical column(s) 600D. The tiles 621D-630D may not be aligned (or partially aligned) with the vertical column 600D. The size (e.g., length and/or width) of the tiles 621D-630D may vary from the size of the vertical column 600D. In one embodiment, a discretization into tiles 621D-630D may not be restricted by the geometry of the vertical column(s) 600D; however, the collected (e.g., aggregate) volume of the tiles 621D-630D may cover at least a portion of the volume of the vertical column(s) 600D.

The representations in FIGS. 6A-6C can also allow accessing a horizontal subset of the model 400 without having to read and cache the entire model 400 from storage. Software components can load parts of the model 400 (e.g., columns or tiles of interest) on-the-fly. This limits hardware usage when a smaller portion of the model 400 is being accessed. In storage, a vertical columns 600A-600D and/or tiles 611A-615A, 621A-630A can be further broken down into data I/O blocks. The size of an I/O block can be optimized for fast read/write from/to storage. The I/O blocks can be processed in parallel using multithreading.

### Distributed Model Data Access

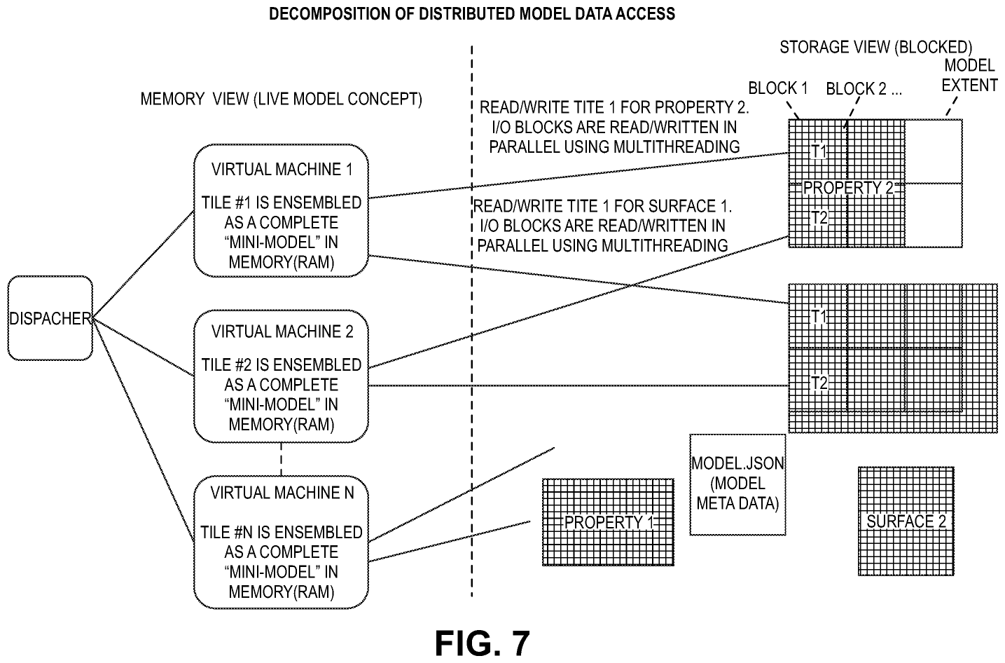

FIG. 7 illustrates a schematic view of distributed model data access, according to an embodiment. The dispatcher can be a software component that acts as a façade of the earth model to the outside world. It receives requests to access and/or modify the model, and it delegates the request to the appropriate virtual machine(s). For example, a request may be to obtain the depths of surface 1 at a particular set of (X, Y, Z) coordinates. In this example, it may be assumed that the coordinate set spans over two tiles, T1 and T2. The dispatcher can compute a map that assigns each (X, Y, Z) coordinate to their corresponding tile. The dispatcher can construct the request to sample Surface 1 at coordinates belonging to Tile 1 and send the request to Virtual Machine 1 (VM1). The dispatcher can construct the request to sample Surface 1 at coordinates belonging to Tile 2 and send the request to Virtual Machine 2 (VM2). VM1 can read model data for T1 from storage block by block. The blocks can be read in parallel using multithreading. VM1 can create a mini earth model in memory (RAM) that corresponds to T1. In an embodiment, VM1 may hold T1 as a model in memory to fulfill subsequent requests for T1 without reading T1 again from storage. The VM1 can sample T1 of Surface 1 at requested coordinates and send the result back to dispatcher. In parallel, VM2 can process T2 following the same procedure above, as for VM1/T1, and send the result back to dispatcher. The dispatcher can merge the results received from VM1 and from VM2 and returns the complete answer back to the requester.

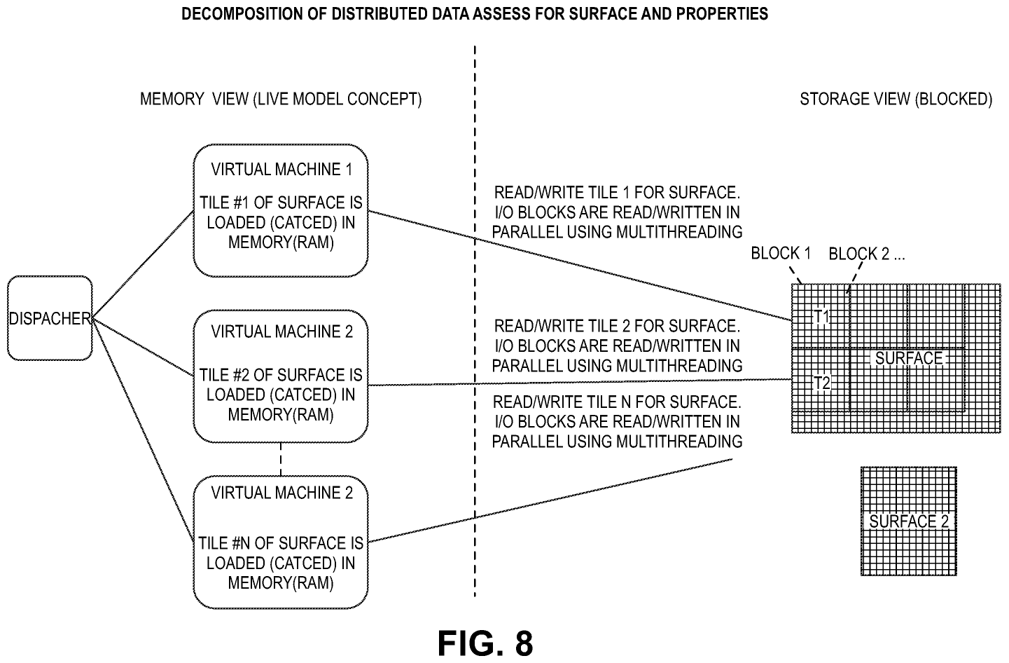

FIG. 8 illustrates a schematic view of a decomposition of distributed data access for surface and properties, according to an embodiment. The same architecture (e.g., pattern: discretize query-split in tiles-distribute to VMs-split in blocks) can be applied to write or update data for a model in a distributed manner. Moreover, the same architecture can be applied to individual objects that make up the model, that is to properties, and to surfaces.

### Concept Associated to the Model Construction On-the-Fly Driven by Query Localization by Combining the Usage of Vertical Pins and a Set of Geological Meta-Information Instructions.

The model assembly can be decomposed as described below. The meta-information can be defined as a set of instructions describing the role and participation of objects to the model. This may include information such as the number of zones, surfaces, and/or properties to include in the model, and their relationships.

An object can be described by a meta-information section. The section can contain the object name, type (e.g., surface, property, zone), geo-localization in space (e.g., a 3D lattice-3D non-aligned axis geometry box), additional attributes (e.g., how many nodes, vertices), or a combination thereof. The meta-information can be self-describing, support basic geo-localization (e.g., for a given (x,y,z) point to determine if the object is affected), and occupy very small memory consumption (e.g., 5 kilobytes or less).

The object can also or instead be described by a bulk-data section. The section can be or include a collection of core data that defines the object. For example, a grid surface can be made up of n grid points, and each grid point can carry information such as z altitude and/or diagonal orientation. In another example, a 3D grid property can be made up of an 3D array of values (e.g., float) for simple scalar property (e.g., compressional velocity, shear velocity), or can be a 3D array of two float values for a structure tensor (e.g., dip/azimuth).

The surface data and property data corresponding to each instruction can be added together. Data can include a URL address on where to retrieve on the cloud the meta-information and bulk data that corresponds to the object.

The query can then be performed. The query can include a single action request for a given (x,y,z) point or (e.g., inline/crossline/depth interval) location. The query can also instead include a collection of action requests regularly or irregularly distributed that are covering part or the entirety of the model. The request can include determining the model zone at the requested location (e.g., zone classification). The request can also or instead include evaluating the property value and/or its gradient using different interpolation scheme (e.g., barycentric, tri-linear, tri-cubic). The request can also or instead include evaluating the surface normal direction a zone transition (e.g., lying on surface boundary between two zones) to determine the change of direction of the ray (e.g., reflection, refraction) to apply the Snell's law.

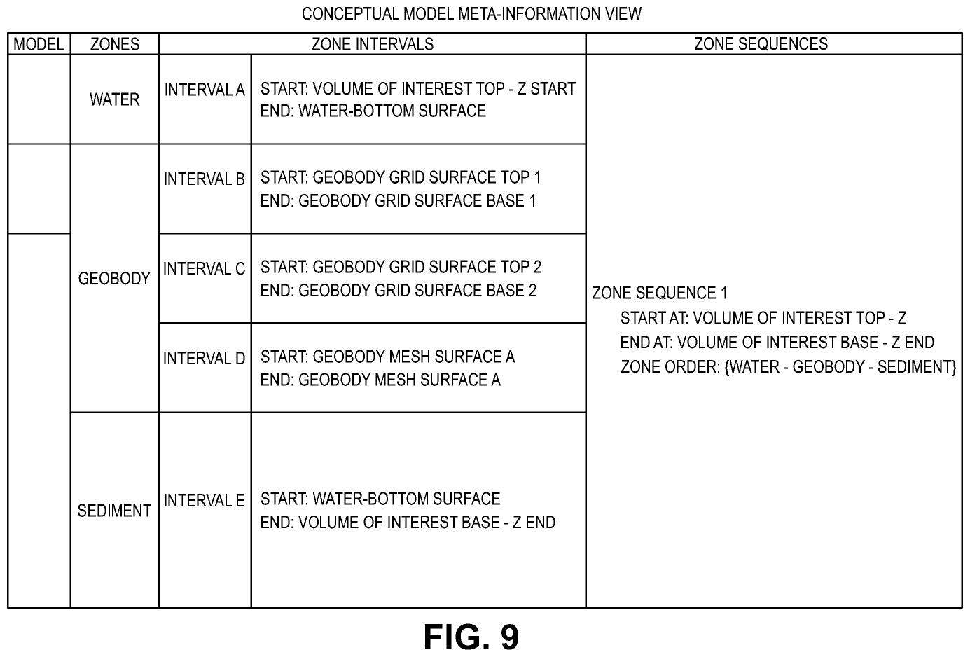

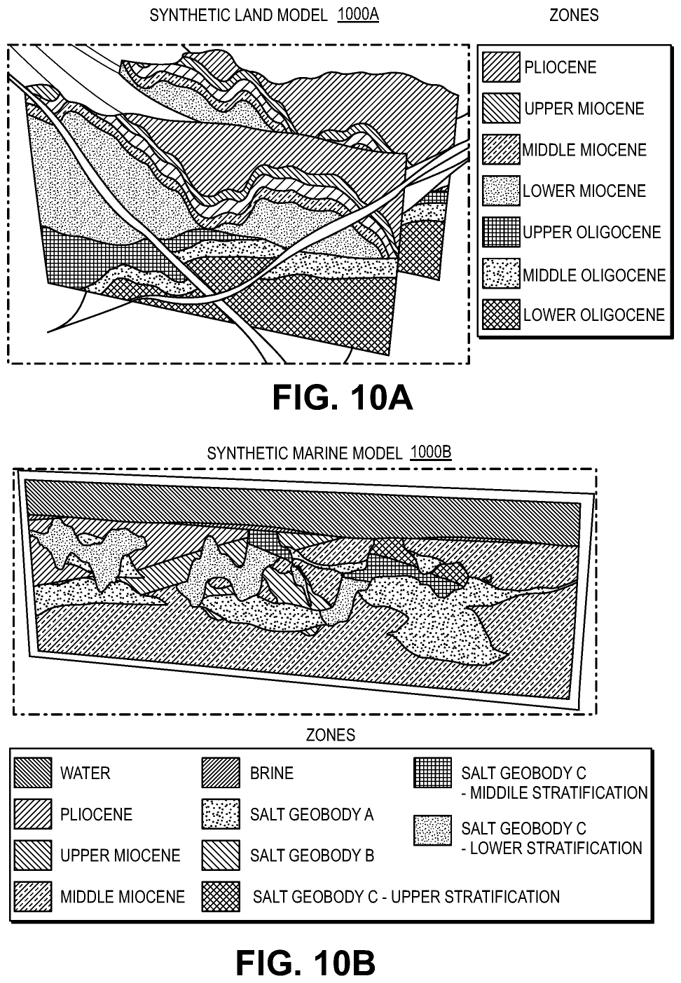

FIG. 9 illustrates a schematic view of a conceptual model meta-information view, according to an embodiment. FIG. 10A illustrates a synthetic land model 1000A, and FIG. 10B illustrates a synthetic marine model 1000B, according to an embodiment. FIGS. 9, 10A, and 10B may show how the meta-information for the model is captured. A user can define the volume of interest (e.g., 3D lattice geometry) that the model is occupying. This can be captured by specifying an origin (e.g., x-origin, y-origin), a corner 1—primary direction (x1, y1), a corner 2—secondary direction (x2, y2), and vertical range (z start, z end). The user can also define a collection of zones-geological units (1-n) to be expected. For each zone, a name can be specified (e.g., water, sediment A, sediment B, geobody A), and a collection of intervals (1-n) that delimit the zone boundary. A zone interval can be delimited by a top and base surface. The user can define 1-n zone sequences. A zone sequence can be or include a priority-logical order per a sub-collection of zones and an interval zone indicating where this sequence is active and/or can be applied. The priority-logical order indicates which zone takes precedence over other zones. The user can also define the logical-priority order between the different zone sequences that are defined. Within the model, this may include which zone sequence takes precedence over other zones. The user can assign property packages to each zone. A property package is a group of properties that describes the material behavior to expect (e.g., isotropic, anisotropic) and provide validation checks.

### Usage of Vertical Pins and a Set of Geological Meta-Information Instructions to Determine the Zone Classification on Demand

Meta-information of a model can be described as follows:
Surfaces participating: [Surface1, Surface2, . . . ] denotes an array of surface names
Zones participating: [Zone1, Zone2, . . . ] denotes an array of zone names
Zone <name>[(Start: . . . , End: . . . ), (Start: . . . , End: . . . ), . . . ] denotes an array of (e.g., two) zone intervals
Zone sequences: [(Start: . . . , End: . . . , Order: { . . . }), (Start: . . . , End: . . . , Order: { . . . }) . . . ] denotes an array of (e.g., two) zone sequences

To determine which zone a point belongs to, a vertical pin may be passed/shot through the point, and intersections with the surfaces may be determined. The zone sequence that contains the point may then be located. This can be done by using an interval pair containment defined by the start-end z intersection of the zone sequence. This may be iterated on the zones of the selected zone sequence using the logical-priority order. This may also or instead be iterated on the zone intervals of the selected zone. The zone interval that contains the point can then be located. This can be done by using an interval pair containment defined by the start-end z intersection of the zone interval. Once zone interval containment is found, the zone may be assigned to this point.

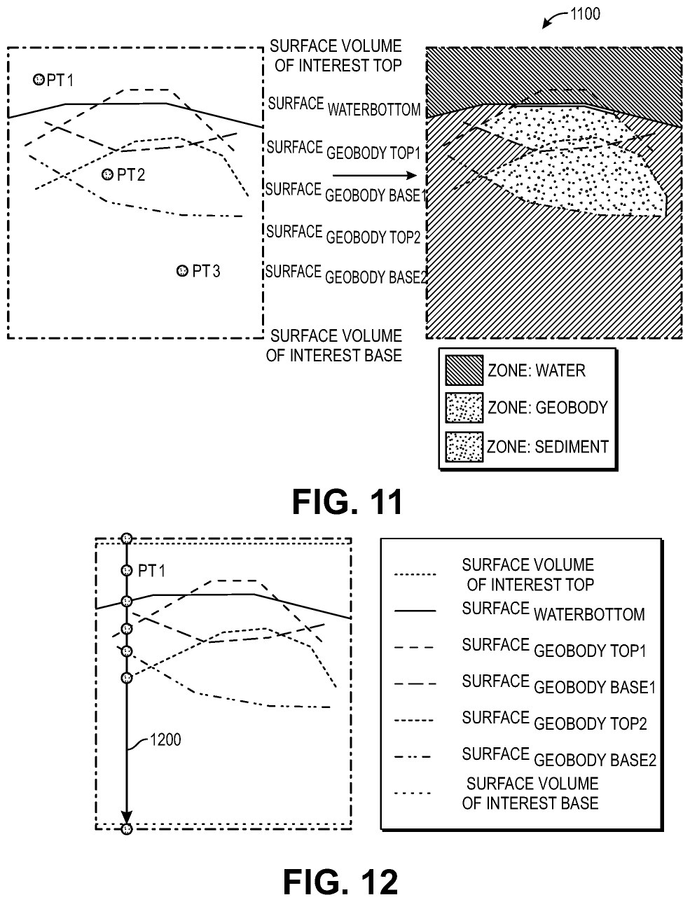

FIG. 11 illustrates a cross-section of a model (e.g., model 400), according to an embodiment. An example is now provided to demonstrate how the set of meta-information instructions combined with a vertical pin strategy determines without ambiguity the zone a single point query belongs to and evaluates its property value. In FIG. 11, a model 1100 is defined, containing 7 surfaces (e.g., volume of interest top, water bottom, geobody top1, geobody base1, geobody top2, geobody Base2, volume of interest base) and 3 zones (water, geobody, and sediment).

Meta-information for the model 1100 can be defined as follows:
Surfaces participating: [volume of interest top, water bottom, geobody top1, geobody base1, geobody top2, geobody base2, volume of interest base]
Zones participating: [water, sediment, geobody]
Zone water [(start: volume of interest top, end: water bottom)]
Zone sediment [(start: water bottom, end: volume of interest base)]
Zone geobody [(start: geobody top1, end: geobody base1), (start: geobody top2, end: geobody base2)]
Zone sequences: [(start: volume of interest top, end: volume of interest base, order: {Water, geobody, sediment})]

FIG. 12 illustrates a vertical pin 1200 passing through point Pt1, according to an embodiment. The point Pt1 may be classified by passing a vertical pin 1200 is through Pt1, and the z intersection along every surface can be calculated, as shown in FIG. 12. In this example, the following z intersections are found: {volume of interest top, water bottom, geobody top1, geobody base2, geobody top2, volume of interest base}.

The point is lying inside the zone sequence definition range because the point is located between the volume of interest top and volume of interest base z intersections. The first available zone listed in the zone sequence is the zone water. The user may determine whether the point is lying inside the zone water. The point is located between the volume of interest top and water bottom z intersections, and therefore, the point can be classified as being part of the zone water.

The point Pt2 (see FIG. 11) can be classified by passing a vertical pin through the Pt2, and the z intersection along every surface can be calculated. In this example, the following z intersections are found: {volume of interest top, water bottom, geobody top1, geobody top2, geobody base1, geobody base2, volume of interest base}.

The point is lying inside the zone sequence definition range because the point is located between the volume of interest top and volume of interest base z intersections. The first available zone listed in the zone sequence is the zone water. The user may determine whether the point is lying inside the zone water. The point is outside the interval defined by the intersection [volume of interest top, water bottom], and therefore, the point does not belong to the zone water. The next available zone to check is the zone geobody, iterating on the different zone intervals of the zone geobody. The first zone interval (geobody top1, geobody base1) is well defined as z intersections can be found for the geobody top1 and the geobody base1. However, the point is not lying within this intersection interval range. The second zone interval (geobody top2, geobody base2) is well defined as z intersections can be found for the geobody top2 and the geobody base2. Also, the point is found lying within this intersection interval range. Therefore, the point is classified as being part of the zone geobody

The point Pt3 (see FIG. 11) can be classified by passing a vertical pin through the Pt3, and the z intersection along every surface can be calculated. The following z intersections are found: {volume of interest top, water bottom, geobody top1, geobody top2, geobody base1, geobody base2, volume of interest base}.

The point is lying inside the zone sequence definition range because the point is located between the volume of interest top and volume of interest base z intersections. The first available zone listed in the zone sequence is the zone water. The user may determine whether the point is lying inside the zone water. The point is outside the interval defined by the intersection [volume of interest top, water bottom], and therefore, the point does not belong to the zone water. The next available zone to check is the zone geobody, iterating on the different zone intervals of the zone geobody. The first zone interval (geobody top1, geobody base1) is well defined as z intersections can be found for the geobody top1 and the geobody base1. However, the point is not lying within this intersection interval range. The second zone interval (geobody top2, geobody base2) is well defined as z intersections can be found for the geobody top2 and the geobody base2. Also, the point is not lying within this intersection interval range. There are no more zone intervals for the zone geobody. Therefore, the point does not belong to this zone. The user may look for the next available zone. The next available zone to check is the zone sediment, iterating on the different zone intervals of the zone sediment. The point is located between the water bottom and volume of interest base z intersections and therefore the point is classified as being part of the zone sediment.

Once the zone has been determined for a given point location, evaluating the property value at this location can be done by selecting the appropriate property within the zone (e.g., using the meta-information description), localizing the grid cells containing this point, and/or applying an interpolation technique (e.g., tri-linear, barycentric, tri-cubic). The simplicity of this approach may enable ease of parallelism and decomposition. In essence, a vertical trace of data can be used to classify a point and evaluate its property value. The bulk data representation of a surface/property can be decoupled from the model. The model itself is a set of instructions, and therefore, it can be easily modified. Construction occurs when a query is submitted. In other words, classification and property estimation can be done on-the-fly and on-demand. In case of failure, failure is localized to the size of the construction unit, which is a vertical trace

### Query-Driven Model Assembly

The ability to load any tile of the model on-the-fly allows for tailoring the amount of model data assembled for the purpose of responding to the model query. These data requests can span over localized, small areas of the model (i.e., property value at a point) or over the full model area (i.e., fulfilling the data requests of a seismic data processing algorithm). As the set of instructions used to create the full model can be used to load any tile of the model on-the-fly, both large and small portions of the model can be loaded to fulfill requests. This ability to tailor the size of the model in memory allows for gathering the portions of the model which are relevant to any given query or set of queries. In this way, queries which are localized to a small portion of the model can be fulfilled quickly as a small amount of the model's data is used, and queries spanning larger sections of the model can be decomposed into queries on a collection of smaller pieces of the model allowing for parallel processing of the query.

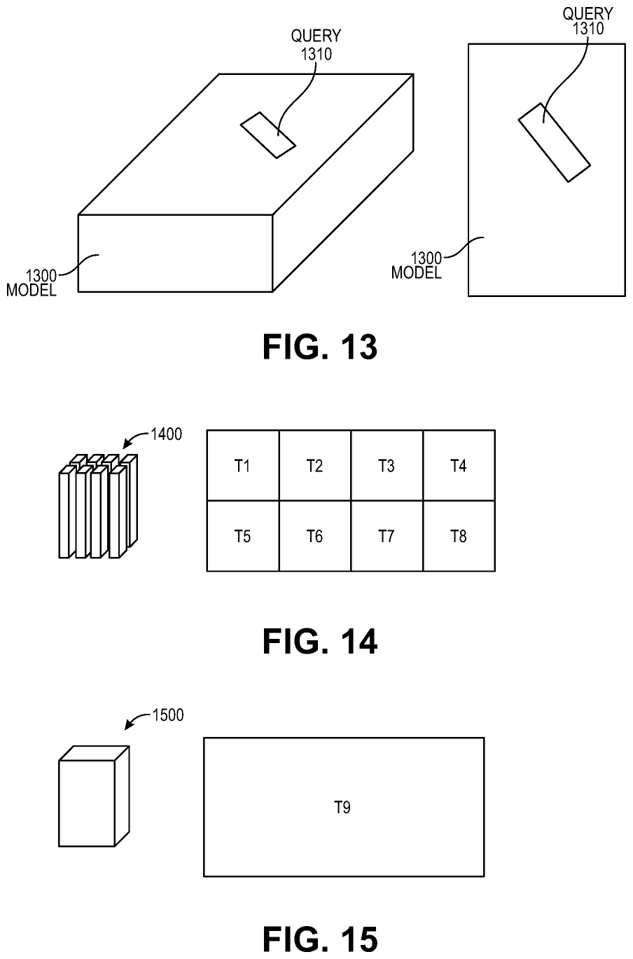

Models loaded into memory may not be constrained by the orientation of the full model geometry (i.e., size or rotation). Model tiles can be defined by a 3D lattice and/or volume of interest, which can be as small as a single column or larger than the size of the model's definition. This volume of interest (or queried area) can also be rotated by any angle about the vertical axis, as shown in FIG. 13, which illustrates a 3D view and a top-down view of a query 1310 on the model 1300, according to an embodiment. As a result, loaded models may or may not be in line with the lattice used to define the model when it was created. Thus, model data can be loaded into tiles in such a way as to align to the relevant geometry of queries received. Furthermore, the size of the loaded model can be decomposed to the minimum amount for a single sub-task of a query to be completed, as shown in FIGS. 14 and 15. More particularly, FIG. 14 illustrates a decomposed query geometry 1400 with 8 tiles (T1-T8), and FIG. 15 illustrates a single tile (T9) spanning the query geometry, according to an embodiment. Decomposing the size of the loaded model may allow for a simple framework of task parallelism to emerge to take advantage of multiple available computers (i.e., a cloud compute engine) or multi-threaded computer architecture (i.e., threads/cores on a single computer). The systems designed to use this model representation to fulfill queries are flexible in their ability to take advantage of the model's decomposition into tiles.

Two performance aspects for enabling the on-the-fly assembly of model tiles are parallel I/O (e.g., data input/output) and the localized storage of object data. The transfer of object data from storage into memory may be able to take place in parallel, with multiple objects (e.g., surfaces or property) having their data transferred at once. As the objects participating in the model can be self-contained and independent of one another, this can be achieved through multi-threading. Object data may not be stored as a monolith, but rather objects can be decomposed into geo-localized blocks for storage to ensure that data local to queries is brought over the network to the machine's memory. For example, a property consisting of a 3D grid of values can be decomposed into a set of hexahedrons of a specified length, width, and depth, converting the single property into n 3D grid blocks. As data is requested by the model, the blocks covering the requested area can be transferred to fill the model. The size of the decomposition of the blocks is tuned for optimal performance for transferring data over the network. By combining these two features, model data can be assembled quickly and in parallel. The relevant data from each participating object's blocks can be transferred in parallel over the network to be loaded into the model tile in memory.

Models, surfaces, and/or properties can be equipped with a geo-localization lattice as part of their meta-data. This shared means of spatial description allows for the same decomposition algorithms to be applied to models, surfaces, and properties. The discretization of a model into tiles can be applied similarly to a property (e.g., for visualizing data quickly in the same distributed manner used for a model). Additionally, this discretization is used for splitting property and surfaces into blocks for storage, taking the full object and tiling it in a geo-localized manner to determine the composition of each storage block.

### Alternate Use and Extensions

The system and method described herein may also or instead be extended to other domains in the field of computed aided design (CAD) including, but not limited to, computer graphics and animation, product visualization and visualization of scientific research (e.g., medicine, car construction, space/aeronautic, mining . . . ), and water reservoir characterization or monitoring. Other possible uses could be extending (or integrating with) GOOGLE® maps to provide information at surface (X, Y) and also at depth, (X, Y, Depth).

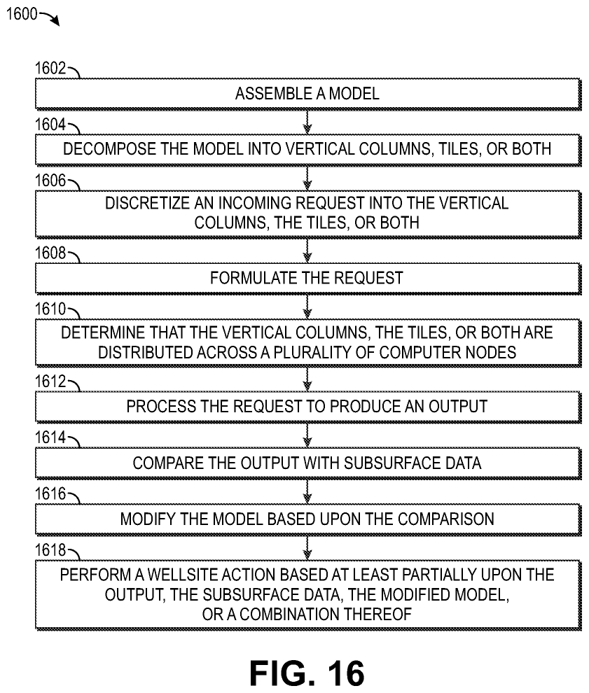

FIG. 16 illustrates a flowchart of a method 1600 for assembling a model (e.g., on-the-fly), according to an embodiment. The model may be or include a distributed, scalable, trace-based imaging earth model representation. An illustrative order of the method 1600 is provided below; however, one or more portions of the method 1600 may be performed in a different order, combined, split, repeated, or omitted.

The method 1600 may include assembling (or generating or receiving) a model, as at 1602. The model may be or include the model 400 in FIG. 4, the model 1000A in FIG. 10A, the model 1000B in FIG. 10B, the model 1100 in FIG. 11, the model 1300 in FIG. 13, or a combination thereof. The model may include a plurality of independent objects (e.g., objects 410A-410G) that participate in the model based at least partially upon a set of instructions governing assembly of the model. The independent objects may be or include surfaces, properties, zones, or a combination thereof. The surfaces may be or include 2D grid surfaces, mesh surfaces, or both. The properties may be or include a 3D grid of values, a 1D property value profile, a constant value, or a combination thereof. The zones may each be bounded by a portion of the surfaces and have a portion of the properties therein.

The method 1600 may also include decomposing the model into vertical columns, tiles, or both, as at 1604. The vertical columns may be or include the columns 600A-600D shown in FIGS. 6A-6C. A smallest unit of the vertical columns is a vertical stack of single 3D grid cells. The tiles may be or include the tiles 611A-615A in FIG. 6B, the tiles 621A-630A in FIG. 6C, the tiles T1 and T2 in FIG. 8, the tiles T1-T8 in FIG. 14, the tile T9 in FIG. 15, or a combination thereof. Each tile may include a 3D volume (e.g., a cuboid). Each tile may be interpreted with the set of instructions as a self-contained model. At least a portion of the model may be configured to be distributed across a plurality of computer nodes. The decomposition of the model may allow the model to have any size and/or to switch between the vertical columns and the tiles (e.g., 3D cuboid), thereby providing scalability.

The method 1600 may also include discretizing an incoming request into the vertical columns, the tiles, or both, as at 1606. The vertical columns, the tiles, or both may cover a zone of interest of the incoming request to drive assembly of at least a portion of the model. The zone of interest refers to a particular portion of the model that corresponds to a particular portion of the subterranean formation.

The method 1600 may also include formulating the request, as at 1608. The request may be formulated by assembling the model (e.g., on-the-fly) using the set of instructions (e.g., dynamically). The request may also or instead be formulated by performing a vertical pin analysis on the model to retrieve a portion of the surfaces and/or a portion of the properties that are geo-located in the vertical columns, the tiles, or both.

The method 1600 may also include determining that the vertical columns, the tiles, or both are distributed across the plurality of computer nodes, as at 1610.

The method 1600 may also include processing the request, as at 1612. The request may be processed by localizing the 3D cuboid and/or applying an operator (e.g., a trace-based operator) to model data (e.g., the portion of the surfaces and/or the portion of the properties) that is geo-located in the vertical columns, the tiles, or both to produce an output. Localizing the 3D cuboid may include identifying relationships (e.g., mapping) between (1) the request and (2) the vertical columns, the tiles, or both. The operator may be or include a mathematical function.

The method 1600 may also include comparing the output with subsurface data, as at 1614. The subsurface data may be measured or acquired at a wellsite using ray tracing, full waveform inversion (FWI)), or the like.

The method 1600 may also include modifying the model based at least partially upon the comparison, as at 1616.

The method 1600 may also include performing a wellsite action, as at 1618. The wellsite action may be performed based at least partially upon and/or at least partially in response to the output, the subsurface data, the modified model, or a combination thereof. The wellsite action may be or include selecting a location at a wellsite to drill a wellbore into a subterranean formation, drilling the wellbore, varying a trajectory of the wellbore, varying a rate of penetration of a bottom hole assembly (BHA) that is drilling the wellbore, varying a weight on the drill bit (WOB) in the BHA, varying a flow rate and/or composition of a fluid pumped into the wellbore, or a combination thereof. In one embodiment, the computing system may transmit a signal (e.g., to a user or equipment) to instruct a user or equipment to perform the wellsite action.

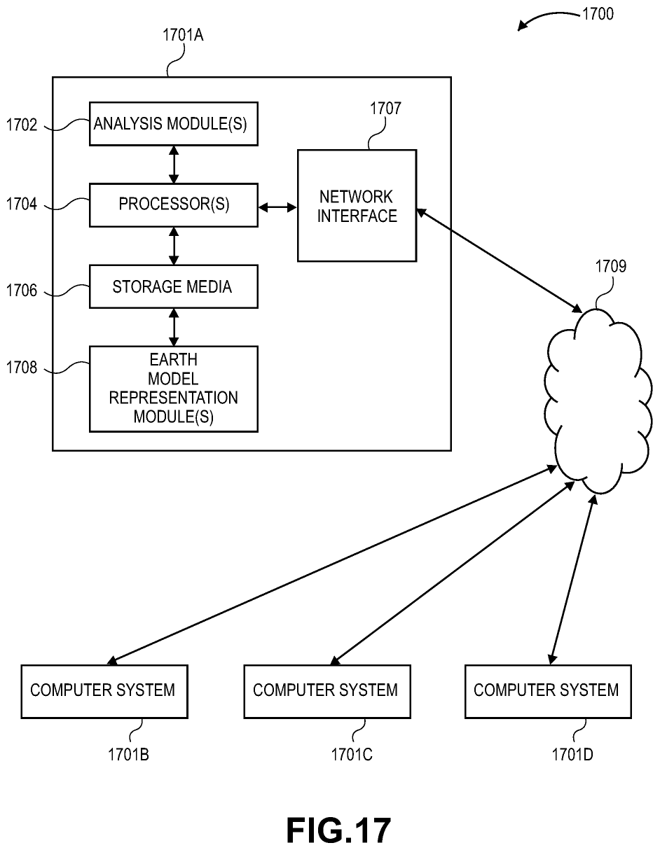

In some embodiments, any of the methods of the present disclosure may be executed by a computing system. FIG. 17 illustrates an example of such a computing system 1700, in accordance with some embodiments. The computing system 1700 may include a computer or computer system 1701A, which may be an individual computer system 1701A or an arrangement of distributed computer systems. The computer system 1701A includes one or more analysis module(s) 1702 configured to perform various tasks according to some embodiments, such as one or more methods disclosed herein. To perform these various tasks, the analysis module 1702 executes independently, or in coordination with, one or more processors 1704, which is (or are) connected to one or more storage media 1706. The processor(s) 1704 is (or are) also connected to a network interface 1707 to allow the computer system 1701A to communicate over a data network 1709 with one or more additional computer systems and/or computing systems, such as 1701B, 1701C, and/or 1701D (note that computer systems 1701B, 1701C and/or 1701D may or may not share the same architecture as computer system 1701A, and may be located in different physical locations, e.g., computer systems 1701A and 1701B may be located in a processing facility, while in communication with one or more computer systems such as 1701C and/or 1701D that are located in one or more data centers, and/or located in varying countries on different continents).

A processor can include a microprocessor, microcontroller, processor module or subsystem, programmable integrated circuit, programmable gate array, or another control or computing device.

The storage media 1706 can be implemented as one or more computer-readable or machine-readable storage media. Note that while in the example embodiment of FIG. 17 storage media 1706 is depicted as within computer system 1701A, in some embodiments, storage media 1706 may be distributed within and/or across multiple internal and/or external enclosures of computing system 1701A and/or additional computing systems. Storage media 1706 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY© disks, or other types of optical storage, or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In some embodiments, computing system 1700 contains one or more earth model representation module(s) 1708 that may perform at least a portion of one or more of the method(s) described above. It should be appreciated that computing system 1700 is only one example of a computing system, and that computing system 1700 may have more or fewer components than shown, may combine additional components not depicted in the example embodiment of FIG. 17, and/or computing system 1700 may have a different configuration or arrangement of the components depicted in FIG. 17. The various components shown in FIG. 17 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of protection of the invention.

Geologic interpretations, models and/or other interpretation aids may be refined in an iterative fashion; this concept is applicable to embodiments of the present methods discussed herein. This can include use of feedback loops executed on an algorithmic basis, such as at a computing device (e.g., computing system 1700, FIG. 17), and/or through manual control by a user who may make determinations regarding whether a given step, action, template, model, or set of curves has become sufficiently accurate for the evaluation of the subterranean three-dimensional geologic formation under consideration.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. Moreover, the order in which the elements of the methods are illustrated and described may be re-arranged, and/or two or more elements may occur simultaneously. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method, comprising:
assembling a model including a plurality of independent objects, wherein the independent objects include surfaces, properties, and zones;
decomposing the model into vertical columns, tiles, or both;
discretizing an incoming request into the vertical columns, the tiles, or both;
in response to the discretized request, performing a vertical pin analysis on the model to retrieve a portion of the surfaces, a portion of the properties, or both that are geo-located in the vertical columns, the tiles, or both;
modelling the retrieved portions to generate an output;
comparing the output with subsurface data; and
modifying the model based at least partially upon the comparison.

2. The method of claim 1, wherein the independent objects participate in the model based at least partially upon a set of instructions governing assembly of the model.

3. The method of claim 1, wherein a smallest unit of the vertical columns is a vertical stack of single 3D grid cells.

4. The method of claim 1, wherein the surfaces comprise 2D grid surfaces, mesh surfaces, or both, wherein the properties comprise a 3D grid of values, a 1D property value profile, a constant value, or a combination thereof, and wherein the zones are each bounded by a portion of the surfaces and have a portion of the properties therein.

5. The method of claim 1, wherein each tile comprises a 3D volume.

6. The method of claim 1, wherein each tile is interpreted as a self-contained model.

7. The method of claim 1, wherein the vertical columns, the tiles, or both into which the request is discretized cover a zone of interest of the request to drive assembly of a portion of the model.

8. The method of claim 1, wherein the decomposition of the model allows the model to have any size and to switch between the vertical columns and a 3D volume.

9. The method of claim 1, comprising measuring the subsurface data at a wellsite using ray tracing or full waveform inversion (FWI).

10. The method of claim 1, comprising performing a wellsite action based at least partially upon the modified model.

11. A computing system, comprising:
one or more processors; and
a memory system comprising one or more non-transitory computer-readable media storing instructions that, when executed by at least one of the one or more processors, cause the computing system to perform operations, the operations including:
assembling a model including a plurality of independent objects that participate in the model based at least partially upon a set of instructions governing assembly of the model, the independent objects include surfaces, properties, and zones;
decomposing the model into vertical columns, tiles, or both, wherein a smallest unit of the vertical columns is a vertical stack of single 3D grid cells, and each tile includes a 3D volume;
discretizing an incoming request into the vertical columns, the tiles, or both that cover a zone of interest of the request to drive assembly of a portion of the model;
formulating the request by assembling the model using the set of instructions and performing a vertical pin analysis on the model to retrieve a portion of the surfaces and a portion of the properties that are geo-located in the vertical columns, the tiles, or both;
processing the request by localizing the 3D volume and applying an operator to model data that is geo-located in the vertical columns, the tiles, or both to generate an output;
comparing the output with subsurface data measured at a wellsite; and
modifying the model based at least partially upon the comparison.

12. The computing system of claim 11, wherein the surfaces include 2D grid surfaces, mesh surfaces, or both, wherein the properties comprise a 3D grid of values, a 1D property value profile, a constant value, or a combination thereof, and the zones are each bounded by a portion of the surfaces and have a portion of the properties therein.

13. The computing system of claim 11, wherein the decomposition of the model enables the model to have any size and to switch between the vertical columns and the 3D volume.

14. The computing system of claim 11, wherein localizing the 3D volume includes identifying relationships between the request and the vertical columns, the tiles, or both, and the operator includes a mathematical function.

15. The computing system of claim 11, wherein the operations comprise transmitting a signal to cause a wellsite action to be performed based at least partially upon the modified model.

16. A non-transitory computer-readable medium storing instructions that, when executed by at least one processor of a computing system, cause the computing system to perform operations, the operations comprising:
assembling a model including a plurality of independent objects that participate in the model based at least partially upon a set of instructions governing assembly of the model, the independent objects include surfaces, properties, and zones, the surfaces include 2D grid surfaces, mesh surfaces, or both, the properties include a 3D grid of values, a 1D property value profile, a constant value, or a combination thereof, and the zones are each bounded by a portion of the surfaces and have a portion of the properties therein;
decomposing the model into vertical columns, tiles, or both, a smallest unit of the vertical columns is a vertical stack of single 3D grid cells, each tile includes a 3D volume, each tile is interpreted with the set of instructions as a self-contained model, and the decomposition of the model allows the model to have any size and to switch between the vertical columns and the 3D volume;
discretizing an incoming request into the vertical columns, the tiles, or both that cover a zone of interest of the request to drive assembly of a portion of the model;
formulating the request by assembling the model on-the-fly using the set of instructions and performing a vertical pin analysis on the model to retrieve a portion of the surfaces and a portion of the properties that are geo-located in the vertical columns, the tiles, or both;
processing the request by localizing the 3D volume and applying an operator to model data that is geo-located in the vertical columns, the tiles, or both to generate an output, localizing the 3D volume includes identifying relationships between the request and the vertical columns, the tiles, or both, and the operator includes a mathematical function;
comparing the output with subsurface data measured at a wellsite;
modifying the model based at least partially upon the comparison; and
transmitting a signal to cause a wellsite action to be performed based at least partially upon the modified model.

17. The medium of claim 16, wherein the 3D volume includes a 3D cuboid.

18. The medium of claim 16, wherein the operator includes a trace-based operator.

19. The medium of claim 16, wherein the subsurface data is measured or acquired using ray tracing or full waveform inversion (FWI).

20. The medium of claim 16, wherein the wellsite action includes drilling a wellbore, varying a trajectory of the wellbore, varying a rate of penetration of a bottom hole assembly (BHA) that is drilling the wellbore, varying a weight on a drill bit (WOB) in the BHA, varying a flow rate of a fluid pumped into the wellbore, varying a composition of the fluid pumped into the wellbore, or a combination thereof.
